(19) United States
(12) Patent Application Publication
(10) Pub. No.: US 2022/0204698 A1
(43) Pub. Date: Jun. 30, 2022

(54) Polyimide And Film Formed Therefrom

(71) Applicant: MICROCOSM TECHNOLOGY CO., LTD., Tainan City (TW)

(72) Inventors: Steve Lien-chung Hsu, Tainan City (TW); Chun-Heng Chen, Tainan City (TW); Bo-Hung Lai, Tainan City (TW); Yu-Chiao Shih, Tainan City (TW)

(73) Assignee: MICROCOSM TECHNOLOGY CO., LTD., Tainan City (TW)

(21) Appl. No.: 17/404,531

(22) Filed: Aug. 17, 2021

(30) Foreign Application Priority Data
Dec. 25, 2020 (TW) 109146306

(51) Int. Cl. C08G 73/10; C08J 5/18

(52) U.S. Cl. CPC C08G 73/1085; C08J 2379/08; C08J 5/18

(57) ABSTRACT

The present invention provides a polyimide comprising a structural unit, which comprises a first structural unit represented by formula (1) and a second structural unit represented by formula (2), wherein A, D and E are defined herein. A polyimide film formed by the polyimide has a low linear thermal expansion coefficient.

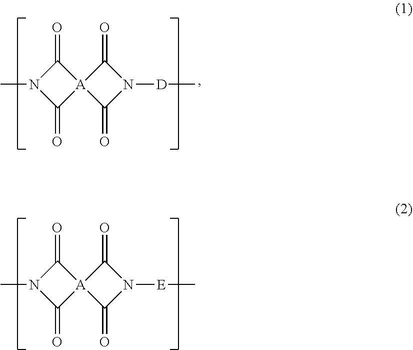

### BACKGROUND OF THE INVENTION

This application claims priority under 35 U.S.C. § 119 to Taiwanese Patent App. No. 109146306, filed Dec. 25, 2020, the entirety of which is incorporated by reference herein.

### FIELD OF THE INVENTION

The present invention relates to a polyimide and, in particular, to a polyimide having a branched chain containing an amide group.

### DESCRIPTION OF THE PRIOR ART

With the development of displays, thinning, lightweight, and even flexibility have become the current direction of display development. Therefore, how to make glass substrates thinner and lighter, and even replace glass substrates with plastic substrates is a problem that the industry is thinking about. Since current displays are driven by thin film transistors, thin film transistors need to be fabricated on the substrate. These thin-film transistors are mainly composed of inorganic materials. The formation requires high-temperature processes and the plastic substrate materials that can withstand such high temperature are limited. When the coefficient of linear thermal expansion between the plastic substrate and the inorganic film material is large, the film may bend and damage the inorganic material. Therefore, the plastic substrate must have the same linear thermal expansion coefficient as the inorganic material. In addition, if the display needs to transmit light from the plastic substrate, such as the down-emitting organic EL etc., the plastic substrate must be transparent and, in particular, must have high light transmittance in the wavelength region below 400 nm.

Polyimide polymer is a kind of plastic material with thermal stability, high mechanical strength and chemical resistance. However, due to molecular structure, it is easy to cause charge transfer between molecules and within molecules, resulting in the yellow appearance of polyimide, which limits its application. In order to reduce the phenomenon of charge transfer, generally, linkage groups can be introduced to make the main chain flexible, or some larger groups can be introduced to destroy the stacking situation, and the effect can also be achieved. Common linkage groups are, for example, (—O—), (—CO—), (—CH₂—), (—C(CF₃)₂—), etc. In addition, it has also been proposed to use a highly transparent semi-alicyclic polyimide formed by combining an alicyclic tetracarboxylic dianhydride that does not cause charge transfer with an aromatic diamine Such a semi-alicyclic polyimide has both transparency and bending properties. However, whether it is the introduction of linkage groups, alicyclic dianhydrides or alicyclic diamines to achieve transparency, the linear thermal expansion coefficient will become larger due to the introduction of these groups such that the semi-alicyclic polyimide cannot be used for the thin film transistor base material of the display.

### SUMMARY OF THE INVENTION

In view of the above technical problems, an object of the present invention is to provide a polyimide film suitable for display thin film transistors or solar cells. Specifically, a polyimide film with a low linear thermal expansion coefficient is provided.

To achieve the above object, the present invention provides a polyimide comprising a structural unit, which comprises a first structural unit represented by formula (1) and a second structural unit represented by formula (2):

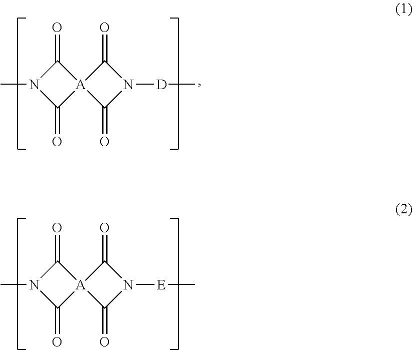

wherein A is each independently a tetravalent organic group containing an alicyclic compound group in its main chain part; D is a divalent residue of a diamine containing an amide group (—CONH₂); E is a divalent residue of a fluorine-containing aromatic diamine, and a yellowness index (YI) of a polyimide film formed by the polyimide is less than 5.

Preferably, the structural unit further includes a third structural unit represented by formula (3), a fourth structural unit represented by formula (4), or both the third structural unit represented by formula (3) and the fourth structural unit represented by formula (4):

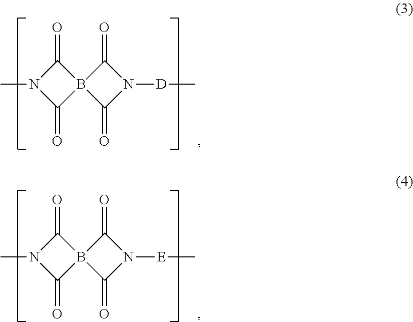

wherein B is independently a tetravalent organic group containing an alicyclic compound group or an aromatic ring group in its main chain part; D is a divalent residue of a diamine containing an amide group; E is a divalent residue of a fluorine-containing aromatic diamine.

Preferably, A is each independently selected from:

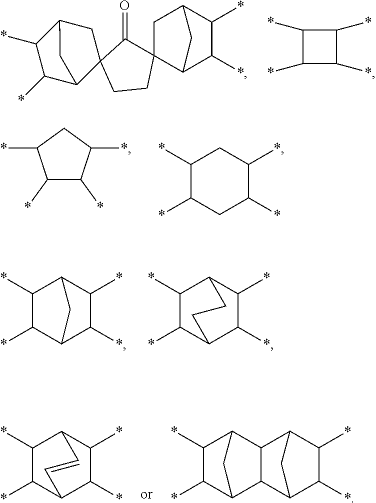

Preferably, B is each independently selected from:

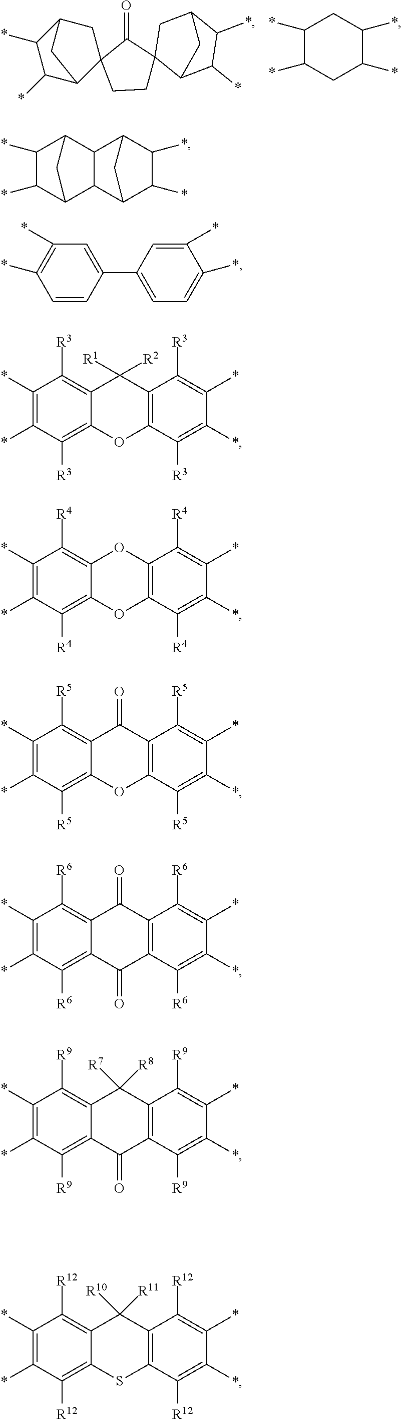

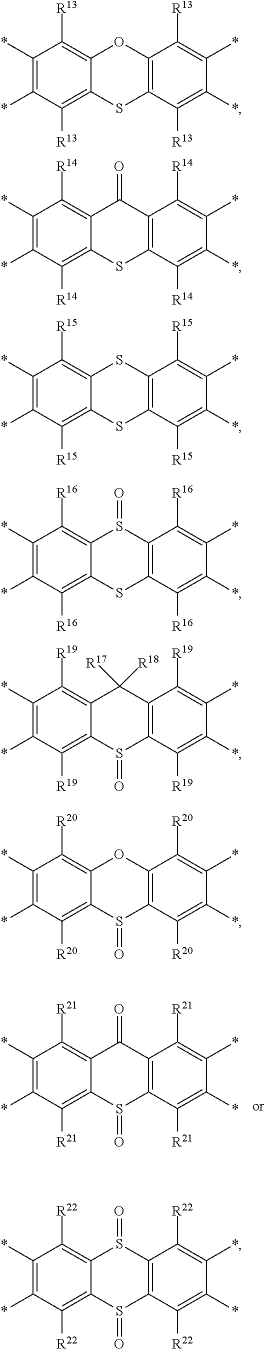

wherein R¹˜R²² are each independently H, F, CF₃ or Ph, and R¹˜R²² are the same or different each time they appear.

Preferably, D is each independently selected from a group represented by formula (5):

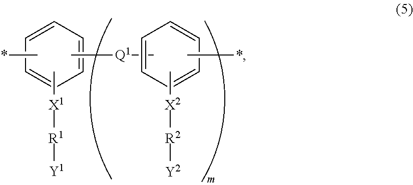

wherein m is an integer from 0 to 5; Q¹ is the same or different each time it appears and each independently —CH₂—, —C₂H₄—, —C₂H₂—, —C₃H₆—, —C₃H₄—, —C₄H₈—, —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears, X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂−, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears, R¹ and R² are each independently a single bond, C1-C30 alkylene, C1-C30 divalent carbocyclic or C1-C30 divalent heterocyclic ring, the alkylene, the divalent carbocyclic and the divalent heterocyclic ring may be substituted by one or more fluorine or organic groups; Y¹ and Y² are the same or different, Y² is the same or different each time it appears, Y¹ and Y² are each independently a hydrogen atom or —CONH₂, provided that at least one of Y¹ and Y² is —CONH₂.

Preferably, D is each independently selected from

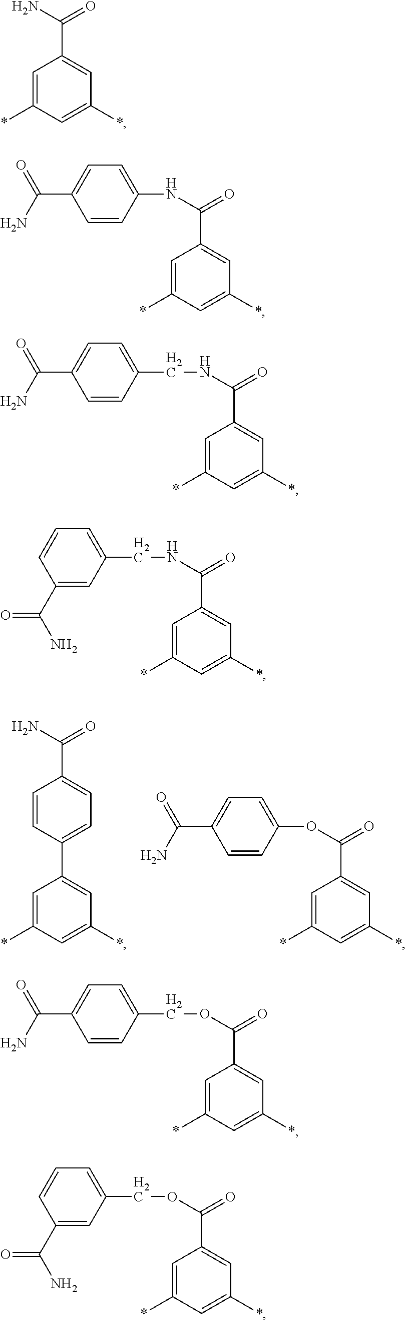

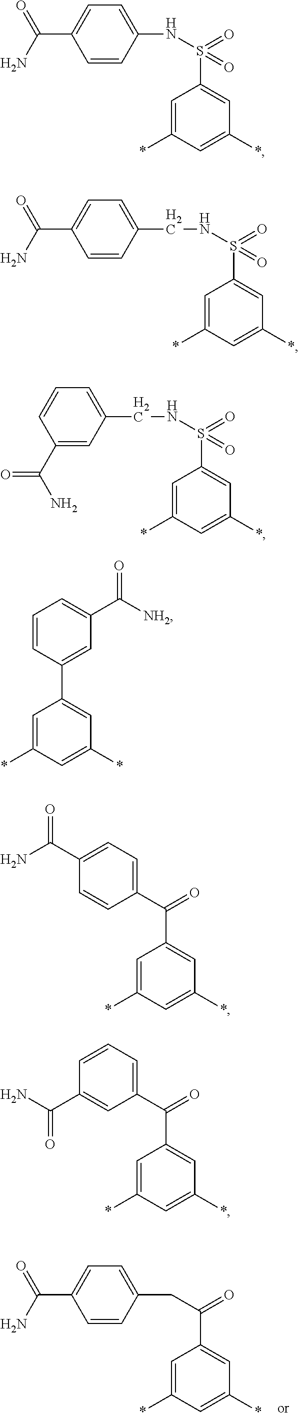

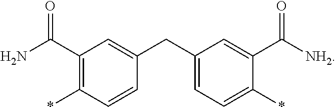 [SMILES: *c1ccc(Cc2ccc(*)c(C(N)=O)c2)cc1C(N)=O]

Preferably, E is each independently selected from a group represented by

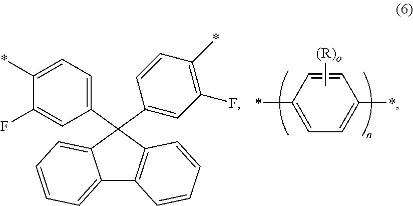

formula (6) or
wherein R is the same or different each time it appears and each independently F, CF₃ or OCF₃; o is the same or different each time it appears and each independently an integer of 0-4; n is an integer of 1-3, provided that at least one o is an integer from 1 to 4.

Preferably, E is each independently selected from

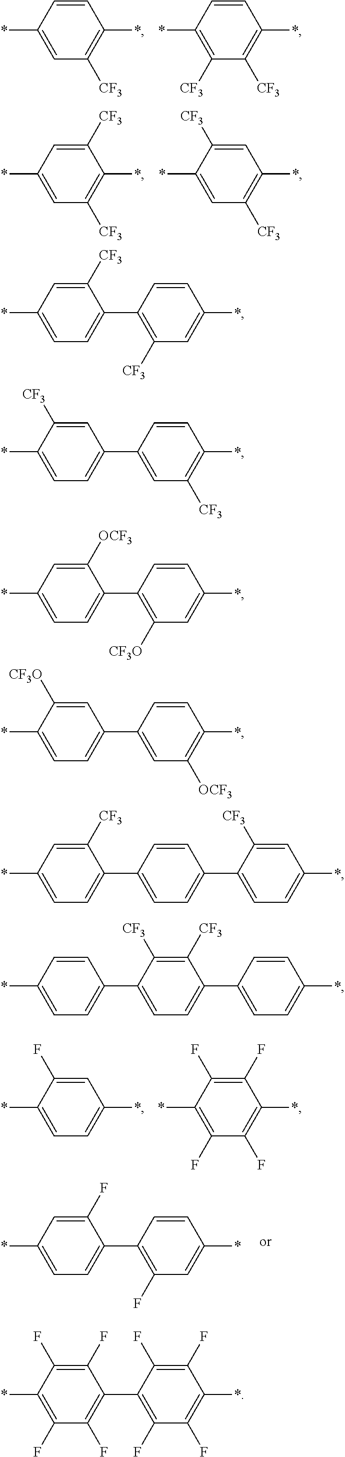

Preferably, a polyimide film formed from the polyimide has a Tg greater than 420° C., and a linear thermal expansion coefficient of the polyimide film between 50° C.˜400° C. is less than 20 ppm.

Preferably, a polyimide film formed from the polyimide is insoluble in organic solvents.

The present invention also provides a polyimide film, which is formed from the polyimide described above.

The polyimide of the present invention is obtained by copolymerizing a diamine monomer containing an amide group and having a specific structure with an aromatic fluorine-containing diamine monomer having a linear structure and a tetracarboxylic dianhydride monomer. The polyimide film prepared from the polyimide not only has transparency and low yellowness index, but also has a low linear thermal expansion coefficient.

### BRIEF DESCRIPTION OF THE DRAWINGS

FIG. 1 is the FTIR spectrum of the polyimide of Example 1.

### DETAILED DESCRIPTION OF THE EMBODIMENTS

As used herein, “*” refers to the connection point.

As used herein, “a divalent residue of a diamine containing an amide group” refers to a divalent group left after removing two amine groups (—NH₂) for polymerization from a diamine monomer containing an amide group. Here are some examples:

| a diamine containing | a divalent residue of a diamine |
|---|---|
| an amide group | containing an amide group |
| 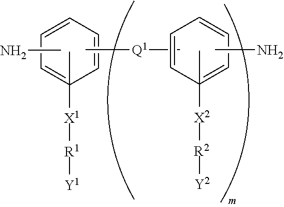 | 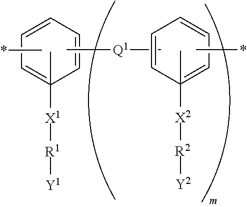 |
| 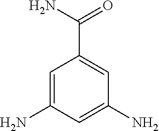 [SMILES: NC(=O)c1cc(N)cc(N)c1] | 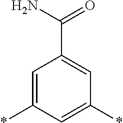 [SMILES: *c1cc(*)cc(C(N)=O)c1] |

As used herein, “a divalent residue of a fluorine-containing aromatic diamine” refers to a divalent group left after removing two amine groups (—NH₂) for polymerization from a fluorine-containing aromatic diamine monomer. Here are some examples:

| a fluorine-containing | a divalent residue of a fluorine- |
|---|---|
| aromatic diamine | containing aromatic diamine |
| 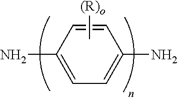 | 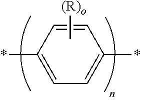 |
| 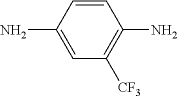 [SMILES: Nc1ccc(N)c(C(F)(F)F)c1] | 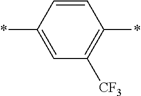 [SMILES: *c1ccc(*)c(C(F)(F)F)c1] |

The polyimide provided by the present invention comprises a structural unit, which comprises a first structural unit represented by formula (1) and a second structural unit represented by formula (2):

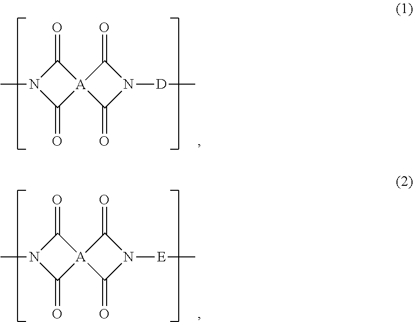

wherein A is each independently a tetravalent organic group containing an alicyclic compound group in its main chain part; D is a divalent residue of a diamine containing an amide group (—CONH₂); E is a divalent residue of a fluorine-containing aromatic diamine, and a yellowness index (YI) of a polyimide film formed by the polyimide is less than 5. It should be noted that when the structural unit includes multiple As, the As are the same or different from each other. When the structural unit includes multiple Ds, the Ds are the same or different from each other. When the structural unit includes multiple Es, the Es are the same or different from each other. The A is preferably an aliphatic tetravalent organic group.

The polyimide comprises the amide group derived from the diamine containing the amide group, which can form a cyano bond after high-temperature dehydration to promote the formation of a bond between the main chains and form a crosslinking structure, thereby improving the thermal and mechanical properties of the polyimide film. In the present invention, the diamine containing the amide group is preferably an aromatic diamine containing an amide group. In a preferred embodiment, the content of the amide group accounts for less than 25% of the number of moles of the polyimide. In a preferred embodiment, the content of the amide group in the polyimide is less than 0.082 mmol/g. In a more preferred embodiment, the content of the amide group in the polyimide is greater than 0.05 and less than 0.082 mmol/g.

The structural unit preferably includes at least two first structural units represented by formula (1) and at least two second structural units represented by formula (2). The As in the first structural units can be the same or different; and the As in the second structural units can be the same or different.

The structural unit may further include a third structural unit represented by formula (3), a fourth structural unit represented by formula (4), or both the third structural unit represented by formula (3) and the fourth structural unit represented by formula (4):

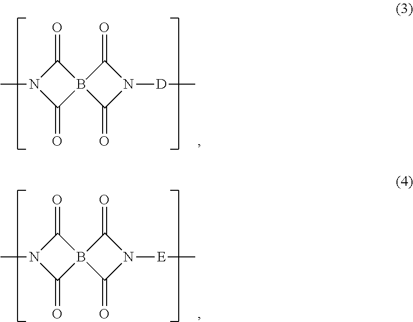

wherein B is each independently a tetravalent organic group containing an alicyclic compound group or an aromatic ring group in its main chain part; D is a divalent residue of a diamine containing an amide group; E is a divalent residue of a fluorine-containing aromatic diamine. It should be noted that when the structural unit includes multiple Bs, the Bs are the same or different from each other. When the structural unit contains multiple Ds, the Ds are the same or different from each other. When the structural unit contains multiple Es, the Es are the same or different from each other. The B may be the same as or different from the A. Preferably, the B is different from the A. In a preferred embodiment, the B is an aliphatic tetravalent organic group.

The A can be each independently selected from:

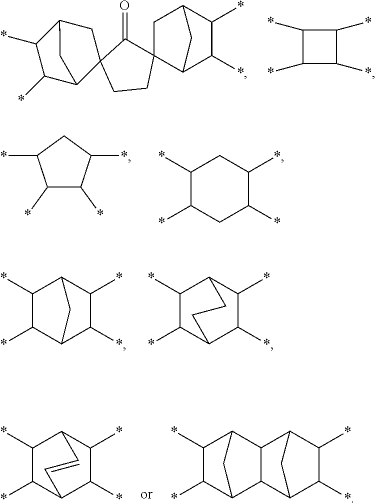

The B can be each independently selected from:

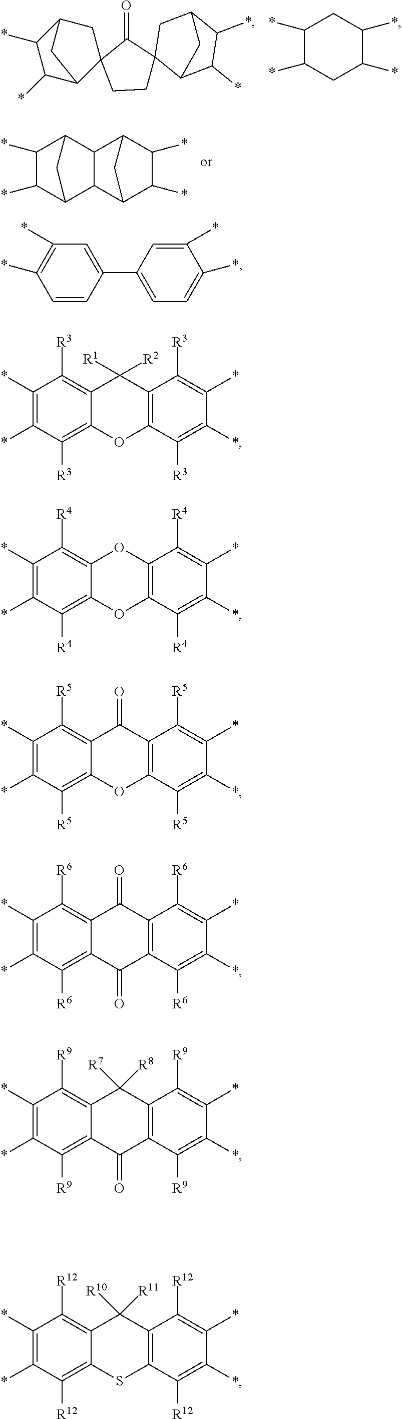

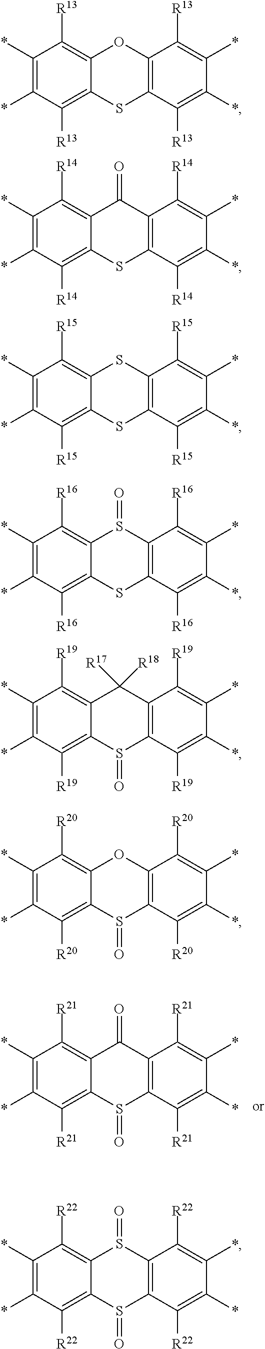

wherein R¹˜R²² are each independently H, F, CF₃ or Ph, and R¹˜R²² are the same or different each time they appear. For example, when there are a plurality of R⁶s, the R⁶s may be the same or different from each other.

The D can be each independently selected from a group represented by formula (5):

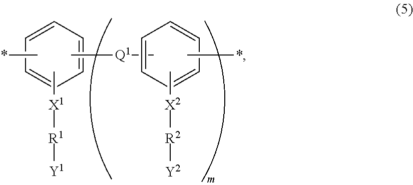

wherein m is an integer from 0 to 5 (such as 1, 2, 3 or 4); Q¹ is the same or different each time it appears (i.e., when there are multiple Q¹s, the Q¹s can be the same or different from each other) and each independently —CH₂—, —C₂H₄—, —C₂H₂—, —C₃H₆—, —C₃H₄—, —C₄H₈—, —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears (i.e., when there are multiple X²s, the X²s can be the same or different from each other), X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears (i.e., when there are multiple R²s, the R²s can be the same or different from each other), R¹ and R² are each independently a single bond, C1-C30 alkylene, C1-C30 divalent carbocyclic or C1-C30 divalent heterocyclic ring, the alkylene, the divalent carbocyclic and the divalent heterocyclic ring may be substituted by one or more fluorine or organic groups; Y¹ and Y² are the same or different, Y² is the same or different each time it appears (i.e., when there are multiple Y²s, the Y^{e}s can be the same or different from each other), Y¹ and Y² are each independently a hydrogen atom or —CONH₂, provided that at least one of Y¹ and Y² is —CONH₂. That is, the D is a group containing the amide group (—CONH₂).

The D can be each independently selected from

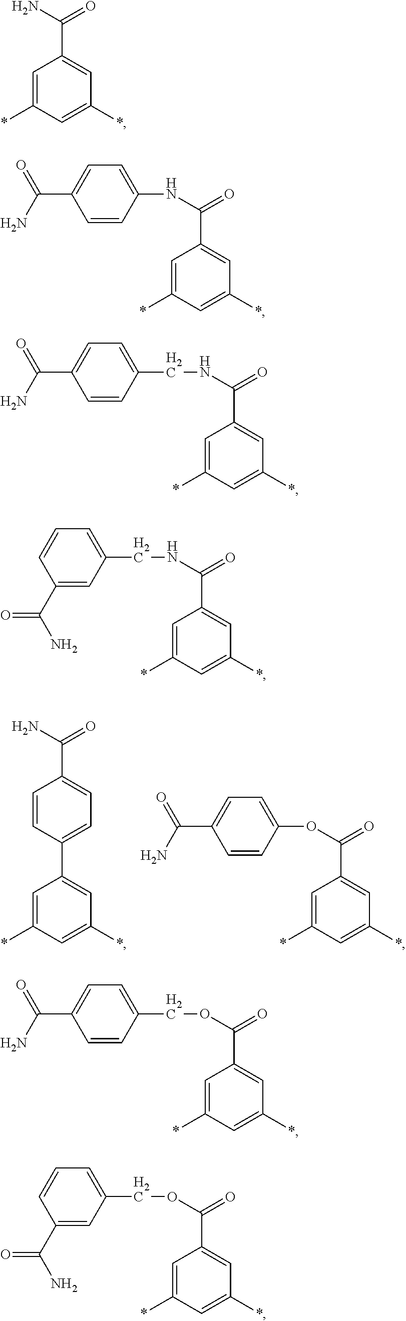

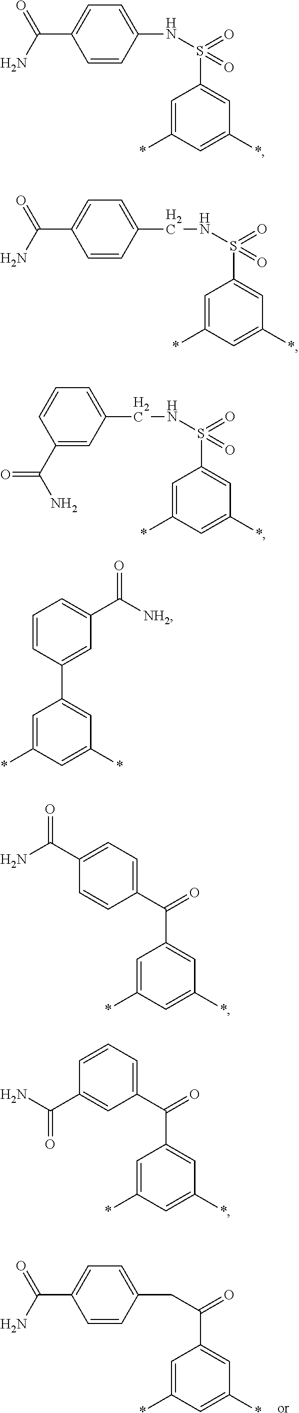

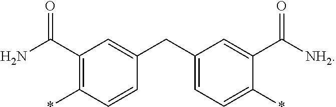 [SMILES: *c1ccc(Cc2ccc(*)c(C(N)=O)c2)cc1C(N)=O]

The E can be each independently selected from a group represented by formula (6) or

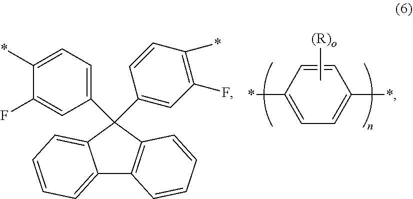

wherein R is the same or different each time it appears (i.e., when there are multiple Rs, the Rs can be the same or different from each other) and each independently F, CF₃ or OCF₃; o is the same or different each time it appears (i.e., when there are multiple os, the os can be the same or different from each other) and each independently an integer of 0-4; n is an integer of 1-3 (i.e., n can be 1, 2 or 3), provided that at least one o is an integer from 1 to 4, such as 1, 2 or 3.

The E can be each independently selected from

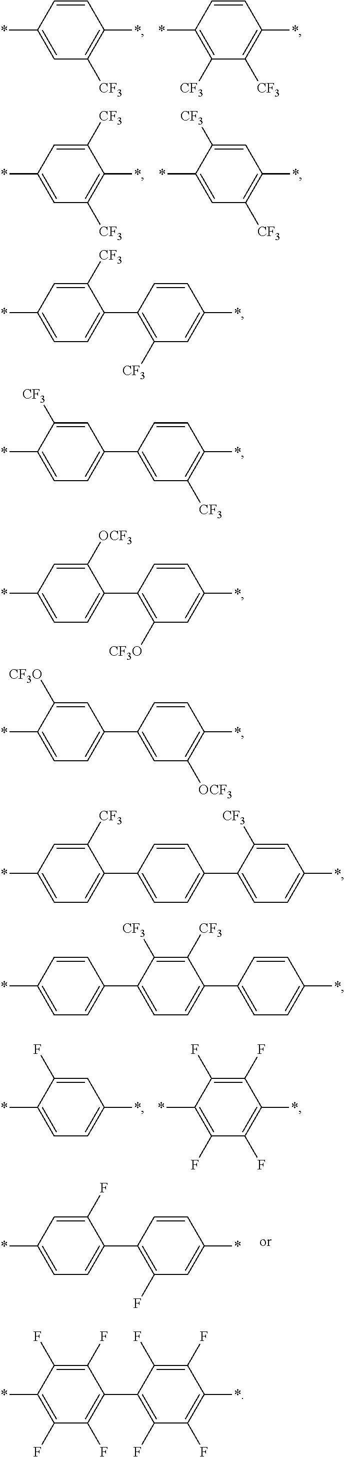

In a preferred embodiment, a polyimide film formed from the polyimide has a Tg greater than 420° C. (such as greater than 423° C., greater than 425° C., greater than 428° C., greater than 430° C. or greater than 433° C.), and a linear thermal expansion coefficient of the polyimide film between 50° C.˜400° C. is less than 20 ppm (such as less than 18 ppm, less than 15 ppm, less than 11 ppm, less than 9.5 ppm or less than 9.3 ppm).

In a preferred embodiment, a polyimide film formed from the polyimide is insoluble in organic solvents. The organic solvent is preferably N,N-dimethylformamide (DMF), N,N-dimethylacetamide (DMAc), N,N-diethylacetamide, N-methylpyrrolidone (NMP), dimethyl sulfoxide (DMSO), m-cresol, dichloromethane, tetrahydrofuran (THF), chloroform, acetone or a mixture of two or more (such as three or more, four or more etc.) of the aforementioned solvents.

In a preferred embodiment, the polyimide does not contain pyrrolone or isoindoloquinazolinedione. In a preferred embodiment, the polyimide does not contain pyrrolidone, nor does it contain isoindolequinazolindione.

The present invention also provides a polyimide film formed from the polyimide described above.

The polyimide film of the present invention can be prepared by the following method. At least one (such as: at least two or at least three) tetracarboxylic dianhydrides, the fluorine-containing aromatic diamine and the diamine containing the amide group are dissolved in the solvent and polymerized by one-step synthesis to obtain the polyimide solution; then the polyimide solution is coated to form a film; and the film is dried. The drying can be carried out at a baking temperature of 230-400° C., such as at 250, 275, 300, 325, 350 or 375° C. In some embodiments, the drying is performed at a temperature between any two of the aforementioned values (such as 250-350° C. or 275-375° C.). The molar ratio of the fluorine-containing aromatic diamine to the diamine containing the amide group is preferably 8-20, preferably 9-19. At such ratio, a polyimide film with low yellowness index can be obtained.

The tetracarboxylic dianhydride can be the tetracarboxylic dianhydride containing the alicyclic compound group in its main chain part or the tetracarboxylic dianhydride containing aromatic ring groups in its main chain part. Examples of the tetracarboxylic dianhydride include but are not limited to 1,2,3,4-cyclobutanetetracarboxylic dianhydride, 4,4′-(4,4′-isopropyldiene diphenoxy) bis(phthalic anhydride), cyclohexane-1,2,4,5-tetracarboxylic dianhydride, 1,1′-bi(cyclohexyl)-3,3′,4,4′-tetracarboxylic dianhydride, 1,1′-bi(cyclohexane)-2,3,3′,4′-tetracarboxylic dianhydride, 1,1′-bi(cyclohexane)-2,2′,3,3′-tetracarboxylic dianhydride, 4,4′-methylene bis(cyclohexane-1,2-dicarboxylic anhydride), 4,4′-(propane-2,2-diyl)bis(cyclohexane-1,2-dicarboxylic anhydride), 4,4′-oxybis(cyclohexane-1,2-dicarboxylic anhydride), 4,4′-thiobis(cyclohexane-1,2-dicarboxylic anhydride), 4,4′-sulfonyl bis(cyclohexane-1,2-dicarboxylic anhydride), 4,4′-(dimethylsilanediyl) bis(cyclohexane-1,2-dicarboxylic anhydride), 4,4′-(tetrafluoropropane-2,2-diyl) bis(cyclohexane-1,2-dicarboxylic anhydride), octahydro-pentalene-1,3,4,6-tetracarboxylic dianhydride, bicyclo[2.2.1]heptane-2,3,5,6-tetracarboxylic dianhydride, (8aS)-hexahydro-3H-4,9-Methylfuran[3,4-g]isopentene-1,3,5,7(3aH)-tetraketone, bicyclo[2.2.2]octane-2,3,5,6-tetracarboxylic dianhydride, bicyclo[2.2.2]oct-5-ene-2,3,7,8-tetracarboxylic dianhydride, tricyclo[4.2.2.02,5]decane-3,4,7,8-tetracarboxylic dianhydride, tricyclo[4.2.2.02,5]dec-7-ene-3,4,9,10-tetracarboxylic dianhydride, 9-oxatricyclo[4.2.1.02,5]nonane-3,4,7,8-tetracarboxylic dianhydride, norbornane-2-spiro-α-cyclopentanone-α′spiro-2′-norbornane-5,5′, 6,6′-tetracarboxylic dianhydride, (4arH,8acH)-decahydro-1t,4t:5c,8c-dimethanonaphthalene-2c,3c,6c,7c-tetracarboxylic dianhydride, (4arH,8acH)-decahydro-1t,4t:5c,8c-dimethanonaphthalene-2t,3t,6c,7c-tetracarboxylic dianhydride, 4,4′-(hexafluoroisopropylene) diphthalic anhydride, 3,3′,4,4′-diphenyl ketone tetracarboxylic dianhydride, 3,3′,4,4′-biphenyltetracarboxylic dianhydride, 2,3,3′,4′-biphenyltetracarboxylic dianhydride, 4,4′-hydroxydiphthalic anhydride, 3, 3′,4,4′-diphenylthiotetracarboxylic dianhydride, biscarboxyphenyldimethylsilane dianhydride, bisdicarboxyphenoxydiphenyl sulfide dianhydride, sulfonyl diphthalic anhydride. These tetracarboxylic dianhydride components may be used alone or in combination.

The solvent used in the polymerization is not particularly limited, and can be m-cresol, N-methylpyrrolidone (NMP), dimethyl sulfoxide (DMSO), dimethylformamide (DMF), dimethylacetamide (DMAc), γ-butyrolactone (GBL), etc., but is not limited thereto.

The method of film formation from the polyimide solution mentioned above is not particularly limited, and can be drop coating, blade coating, spin coating, dip coating, slot die coating, etc., but is not limited thereto.

The yellowness index (YI) of the polyimide film is less than 5, such as less than 4.5, less than 4, less than 3 or less than 2.5. In a preferred embodiment, the total light transmittance of the polyimide film is greater than 85%, such as greater than 90% or greater than 91%.

The following examples will further illustrate the present invention. However, these examples are not used to limit the scope of the present invention. Any changes and modifications made by people having ordinary skill in the art of the present invention without departing from the spirit of the present invention will fall within the scope of the present invention.

Materials:

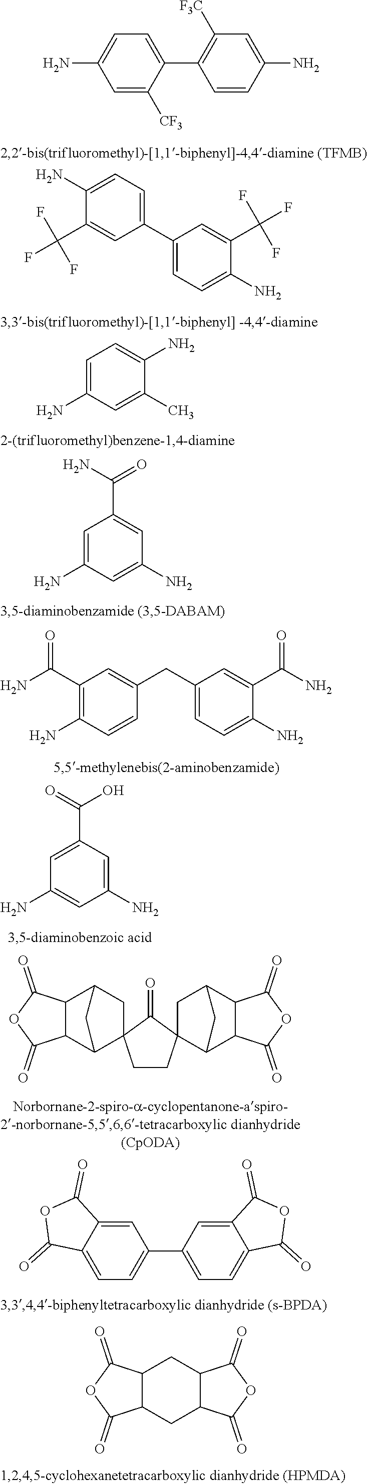

### Example 1

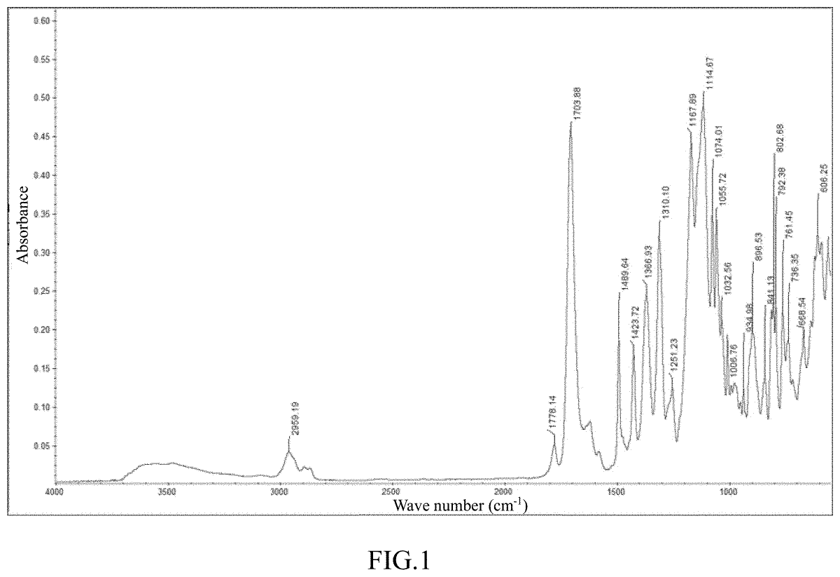

4.5 mmol (mmole) of 2,2′-bis(trifluoromethyl)-[1,1′-biphenyl]-4,4′-diamine (TFMB) and 0.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride (CpODA) was added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 10% of the number of moles of the polyimide. The content of the amide group in the polyimide is 0.156 mmol/g. As shown in FIG. 1, the polyimide in this polyimide solution has at least the following absorption peaks: 2959.19 cm⁻¹(N—H), 1778.14 cm⁻¹(C═O, carbonyl).

### Example 2

4.5 mmol of 2,2′-bis(trifluoromethyl)-[1,1′-biphenyl]-4,4′-diamine (TFMB) and 0.5 mmol of 5,5′-methylene bis(2-aminobenzamide) were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride was added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 20% of the number of moles of the polyimide. The content of the amide group in the polyimide is 0.080 mmol/g.

### Example 3

4.5 mmol of 2,2′-bis(trifluoromethyl)-[1,1′-biphenyl]-4,4′-diamine (TFMB) and 0.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 4 mmol of norbornane-2-spiro-α-cyclopentanone-α′spiro-2′-norbornane-5,5′,6,6′-tetracarboxylic dianhydride and 1 mmol of 3,3′,4,4′-biphenyltetracarboxylic dianhydride (s-BPDA) were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 10% of the number of moles of the polyimide. The content of the amide group in the polyimide is 0.152 mmol/g.

### Example 4

4.5 mmol of 2,2′-bis(trifluoromethyl)-[1,1′-biphenyl]-4,4′-diamine (TFMB) and 0.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 4 mmol of norbornane-2-spiro-α-cyclopentanone-α′spiro-2′-norbornane-5,5′,6,6′-tetracarboxylic dianhydride and 1 mmol of 1,2,4,5-Cyclohexanetetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 10% of the number of moles of the polyimide. The content of the amide group in the polyimide is 0.149 mmol/g.

### Example 5

4.75 mmol of 2,2′-bis(trifluoromethyl)-[1,1′-biphenyl]-4,4′-diamine (TFMB) and 0.25 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 5% of the number of moles of the polyimide. The content of the amide group in the polyimide is 0.316 mmol/g.

### Example 6

4.0 mmol of 2,2′-bis(trifluoromethyl)-[1,1′-biphenyl]-4,4′-diamine (TFMB) and 1.0 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 20% of the number of moles of the polyimide. The content of the amide group in the polyimide is 0.076 mmol/g.

### Example 7

4.5 mmol of 3,3-bis(trifluoromethyl)-[1,1′-biphenyl]-4,4′-diamine (TFMB) and 0.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 10% of the number of moles of the polyimide. The content of the amide group in the polyimide is 0.156 mmol/g.

### Example 8

4.5 mmol of 2-(trifluoromethyl)benzene-1,4-diamine and 0.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 10% of the number of moles of the polyimide. The content of the amide group in the polyimide is 0.127 mmol/g.

### Comparative Example 1

5 mmol of 2,2′-bis(trifluoromethyl)-[1,1′-biphenyl]-4,4′-diamine (TFMB) were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution.

### Comparative Example 2

4 mmol of 2,2′-bis(trifluoromethyl)-[1,1′-biphenyl]-4,4′-diamine (TFMB) and 1 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution.

### Comparative Example 3

3.5 mmol of 2,2′-bis(trifluoromethyl)-[1,1′-biphenyl]-4,4′-diamine (TFMB) and 1.5 mmol of 3,5-diaminobenzamide were added into the reaction vessel and dissolved in N-methylpyrrolidone (NMP) with stirring in nitrogen atmosphere. The amount of solvent was equivalent to 20% by weight of the total solid weight content. After it was completely dissolved, 5 mmol of norbornane-2-spiro-α-cyclopentanone-α′spiro-2′-norbornane-5,5′,6,6′-tetracarboxylic dianhydride were added and stirred for 15 minutes. Afterwards, 3.2 mmol of isoquinoline were added and the reaction temperature was raised to 200° C. The reaction and polymerization were carried out for 24 hours to obtain the polyimide solution. The content of the amide group accounts for 30% of the number of moles of the polyimide. The content of the amide group in the polyimide is 0.050 mmol/g.

The manufacturing method of polyimide film is as what follows:

After the polyimide solutions of the above-mentioned examples and comparative examples were filtered with the filter, they were then coated on the glass substrate by the blade coating method, and baked under a high temperature nitrogen environment at 400° C. to form a polyimide film having a fixed thickness of 15 μm.

The above polyimide film was subjected to the following test.

<Linear Thermal Expansion Coefficient> and <Glass Transition Temperature>

The CTE value and glass transition temperature (Tg) from 50° C. to 200° C. were measured with the thermomechanical analyzer (TA Instrument TMA Q400EM). Before thermal analysis, all polyimide films were heat-treated at 220° C. for 1 hour, and then the glass transition temperature was measured by TMA. In the film mode, the heating rate was 10° C./min and a constant load was applied at 30 mN. Similarly, the linear thermal expansion coefficient from 50 to 200° C. was measured using TMA, in which the load strain was 30 mN, and the heating rate was 10° C./min.

<Yellowness index, YI>

The yellow index YI value of the polyimide film was measured using Nippon Denshoku COH 5500 in accordance with ASTM E313. The yellow index YI was the tristimulus value (x, y, z) measured using the spectrophotometer for the transmittance of 400-700 nm light, and the YI was calculated by the following formula.

YI=100×(1.2769x-1.0592z)/y

<Total Transmittance (TT)>

The total transmittance of the polyimide film was measured using Nippon Denshoku COH 5500 in accordance with ASTM D1003.

<1% weight reduction temperature>

A polyimide film with a film thickness of 15 μm was used as a test piece, and a calorimeter measuring device (Q50001R) manufactured by TA INSTRUMENT was used in a nitrogen gas stream at a temperature rise rate of 10° C./min from 25° C. to 700° C. The 1% weight reduction temperature was calculated from the obtained weight curve.

The test results of the above polyimide film are shown in Table 1.

TABLE 1
The characteristics of the polyimide films of Examples and
Comparative Examples with a thickness of 15 μm.

| | Tg(° C.) | CTE(ppm/° C.) | TT(%) | YI | Td1 % |
|---|---|---|---|---|---|
| Example 1 | 430 | 9.25 | 91.3 | 2.28 | 486 |
| Example 2 | 423 | 14 | 90.8 | 3 | 480 |
| Example 3 | 422 | 19 | 90.3 | 4.3 | 480 |
| Example 4 | 421 | 18 | 91.2 | 3.9 | 459 |
| Example 5 | 420 | 9.7 | 91.5 | 2.1 | 488 |
| Example 6 | 433 | 9 | 90.7 | 3.05 | 457 |
| Example 7 | 428 | 10 | 91.1 | 2.3 | 485 |
| Example 8 | 434 | 8.7 | 90.7 | 2.6 | 487 |
| Comp. | 400 | 22.1 | 91.4 | 3.9 | 490 |
| Example 1 | | | | | |
| Comp. | 408 | 21 | 91.1 | 2.7 | 480 |
| Example 2 | | | | | |
| Comp. | 436 | 8.8 | 90.1 | 5.2 | 445 |
| Example 3 | | | | | |

It is known from Example 1 and Comparative Example 1 that the introduction of the diamine containing the amide group can increase the glass transition temperature (Tg) of the polyimide film, and because the amide groups undergo cross-linking reactions at high temperatures, the linear thermal expansion coefficient (CTE) drops significantly.

It is known from Examples 1, 5, 6 and Comparative Example 3 that when the content of the diamine containing the amide group increases, the Tg increases slightly, and the CTE decreases slightly. However, the yellowness index value YI of the polyimide film will also increase as the content of the diamine containing the amide group increases.

It is known from Example 1 and Comparative Example 2 that when the diamines having similar structures differ in amide group and the carboxyl group, there are completely different results in thermal properties. The diamine introduced with the amide group has a better Tg and a lower CTE. In addition, the thermal properties of the diamine introduced with the carboxyl group is not much different from that of Comparative Example 1 without introduction of the carboxyl group. Therefore, it can be seen that the introduction of the diamine containing the amide group significantly improves the thermal properties.

It can be seen from the above that the polyimide film of the present invention not only has high transparency and colorlessness, but also has excellent heat resistance. Specifically, it has a high glass transition temperature, a high thermal cracking temperature, and a low linear thermal expansion coefficient.

However, the above are only preferred embodiments of the present invention, and should not be used to limit the scope of implementation of the present invention. Therefore, all the simple and equivalent changes and modifications made according to the claims and the specification of the present application are still within the scope of the present invention.

What is claimed is:

1. A polyimide comprising a structural unit, which comprises a first structural unit represented by formula (1) and a second structural unit represented by formula (2): 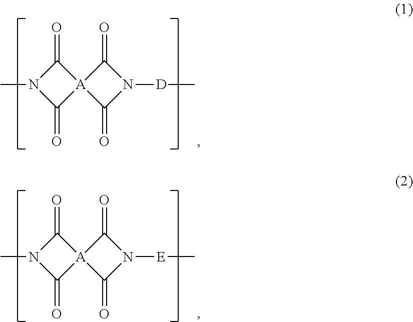
wherein A is each independently a tetravalent organic group containing an alicyclic compound group in its main chain part; D is a divalent residue of a diamine containing an amide group (—CONH₂); E is a divalent residue of a fluorine-containing aromatic diamine, and a yellowness index (YI) of a polyimide film formed by the polyimide is less than 5.

2. The polyimide of claim 1, wherein the structural unit further includes a third structural unit represented by formula (3), a fourth structural unit represented by formula (4), or both the third structural unit represented by formula (3) and the fourth structural unit represented by formula (4): 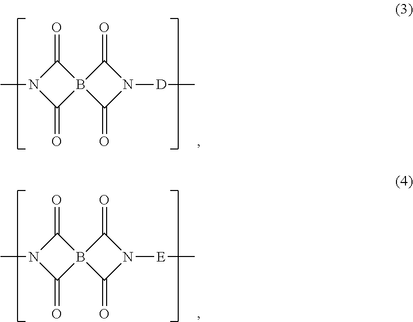
wherein B is independently a tetravalent organic group containing an alicyclic compound group or an aromatic ring group in its main chain part; D is a divalent residue of a diamine containing an amide group; E is a divalent residue of a fluorine-containing aromatic diamine.

3. The polyimide of claim 1, wherein the A is each independently selected from:

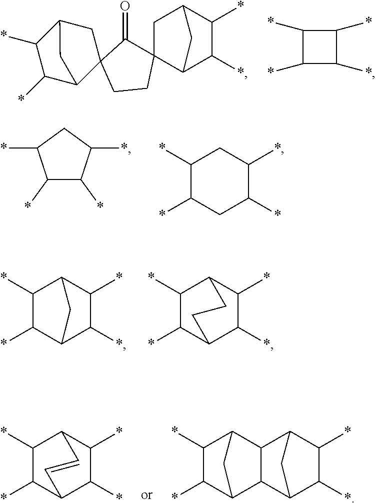

4. The polyimide of claim 2, wherein the B is each independently selected from: 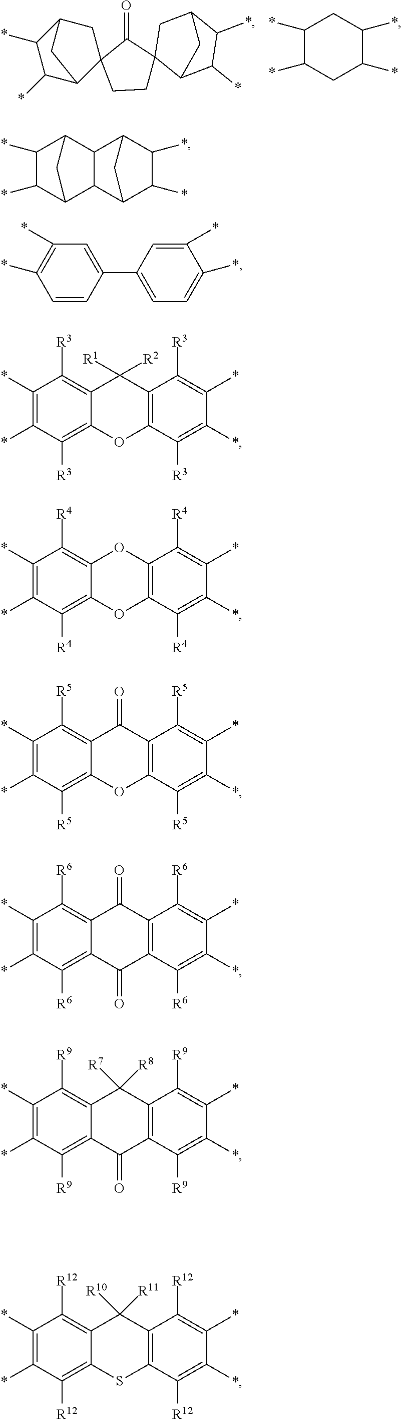 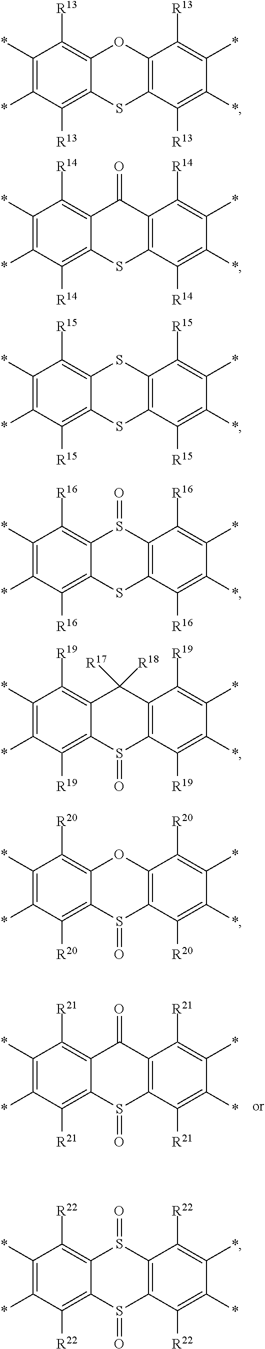
wherein R¹˜R²² are each independently H, F, CF₃ or Ph, and R¹˜R²² are the same or different each time they appear.

5. The polyimide of claim 1, wherein the D is each independently selected from a group represented by formula (5): 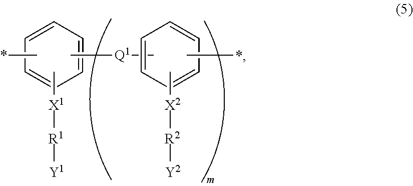
wherein m is an integer from 0 to 5; Q¹ is the same or different each time it appears and each independently —CH₂—, —C₂H₄—, —C₂H₂—, —C₃H₆—, —C₃H₄—, —C₄H₈—, —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears, X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears, R¹ and R² are each independently a single bond, C1-C30 alkylene, C1-C30 divalent carbocyclic or C1-C30 divalent heterocyclic ring, the alkylene, the divalent carbocyclic and the divalent heterocyclic ring may be substituted by one or more fluorine or organic groups; Y¹ and Y² are the same or different, Y² is the same or different each time it appears, Y¹ and Y² are each independently a hydrogen atom or —CONH₂, provided that at least one of Y¹ and Y² is —CONH₂.

6. The polyimide of claim 5, wherein the D is each independently selected from

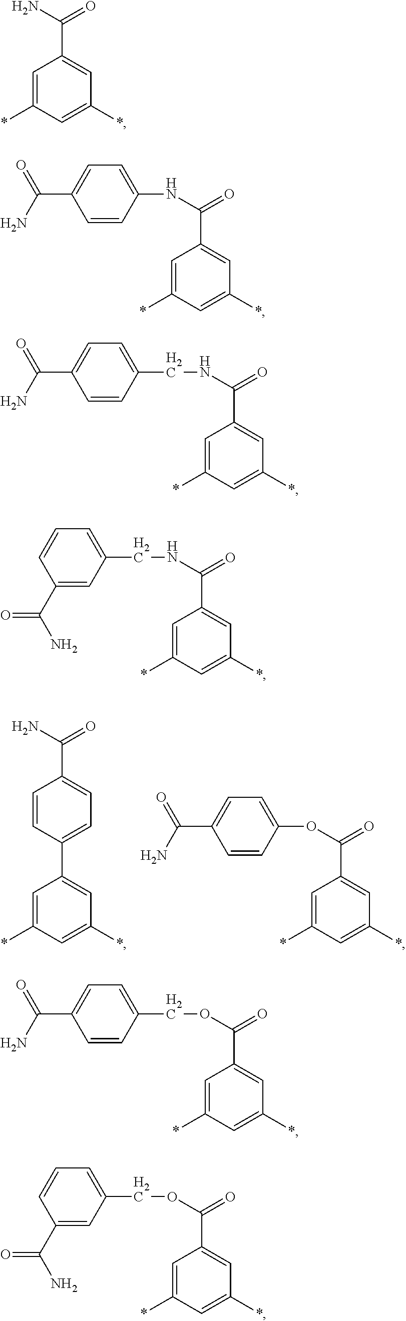

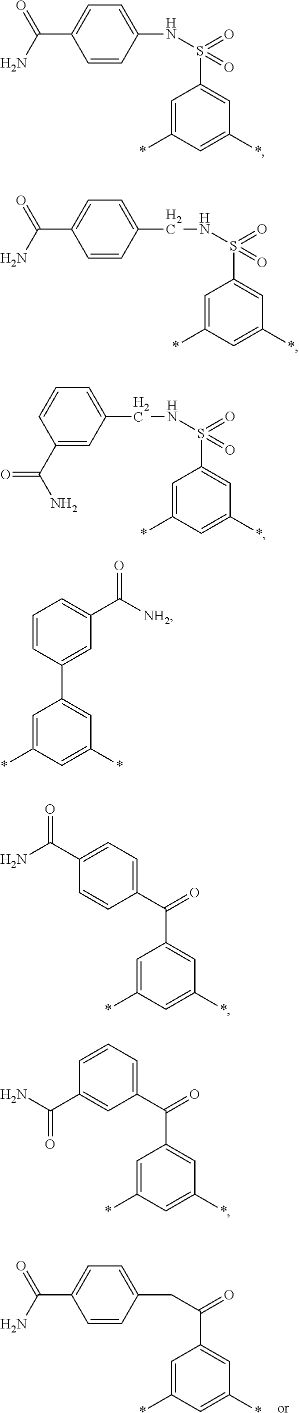

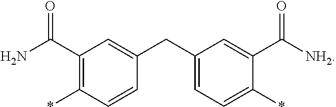 [SMILES: *c1ccc(Cc2ccc(*)c(C(N)=O)c2)cc1C(N)=O]

7. The polyimide of claim 1, wherein the E is each independently selected from a group represented by formula (6) or 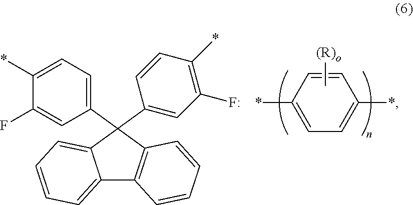
wherein R is the same or different each time it appears and each independently F, CF₃ or OCF₃; o is the same or different each time it appears and each independently an integer of 0-4; n is an integer of 1-3, provided that at least one o is an integer from 1 to 4.

8. The polyimide of claim 7, wherein the E is each independently selected from

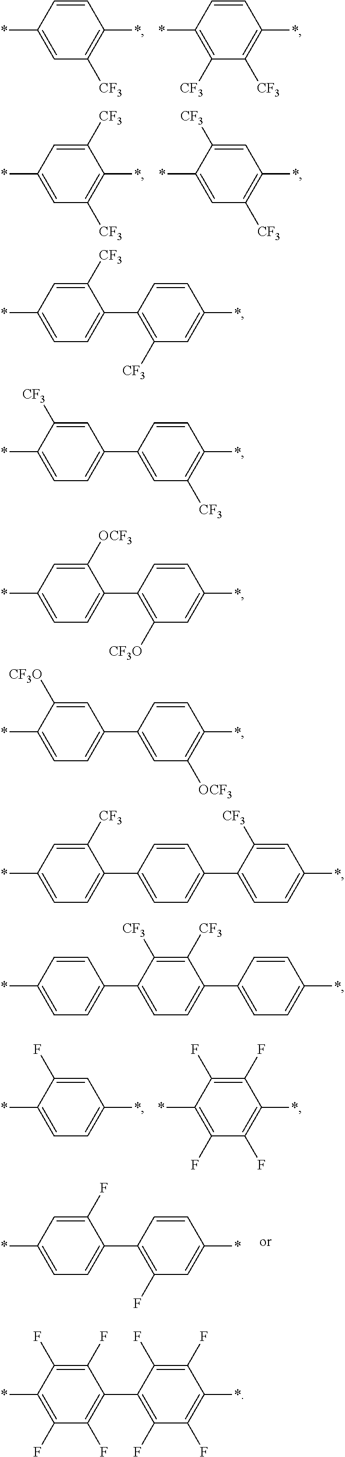

9. The polyimide of claim 1, wherein a polyimide film formed from the polyimide has a Tg greater than 420° C., and a linear thermal expansion coefficient of the polyimide film between 50° C.˜400° C. is less than 20 ppm.

10. The polyimide of claim 1, wherein a polyimide film formed from the polyimide is insoluble in organic solvents.

11. The polyimide of claim 1, wherein the content of the amide group accounts for less than 25% of the number of moles of the polyimide.

12. The polyimide of claim 1, the content of the amide group in the polyimide is less than 0.082 mmol/g.

13. A polyimide film formed from the polyimide of claim 1.

14. The polyimide of claim 2, wherein the D is each independently selected from a group represented by formula (5): 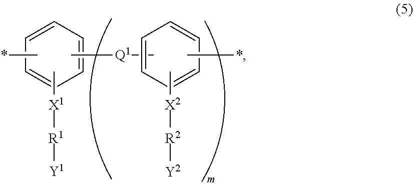
wherein m is an integer from 0 to 5; Q¹ is the same or different each time it appears and each independently —CH₂—, —C₂H₄—, —C₂H₂—, —C₃H₆—, —C₃H₄—, —C₄H₈— —C₄H₆—, —C₄H₄—, —C(CF₃)₂—, —O—, —CONH—, —NHCO—, —COO—, —OCO—, —NH—, —CO—, —SO₂—, —SO₂NH— or —NHSO₂—; X¹ and X² are the same or different, X² is the same or different each time it appears, X¹ and X² are each independently a single bond, —CONH—, —NHCO—, —CONHCH₂—, —CH₂CONH—, —CH₂NHCO—, —NHCOCH₂—, —COO—, —OCO—, —COOCH₂—, —CH₂COO—, —CH₂OCO—, —OCOCH₂—, —CO—, —CH₂CO—, —COCH₂—, —CH₂SO₂NH—, —SO₂NHCH₂—, —NHSO₂CH₂— or —CH₂NHSO₂—; R¹ and R² are the same or different, R² is the same or different each time it appears, R¹ and R² are each independently a single bond, C1-C30 alkylene, C1-C30 divalent carbocyclic or C1-C30 divalent heterocyclic ring, the alkylene, the divalent carbocyclic and the divalent heterocyclic ring may be substituted by one or more fluorine or organic groups; Y¹ and Y² are the same or different, Y² is the same or different each time it appears, Y¹ and Y² are each independently a hydrogen atom or —CONH₂, provided that at least one of Y¹ and Y² is —CONH₂.

15. The polyimide of claim 2, wherein the E is each independently selected from a group represented by formula (6) or 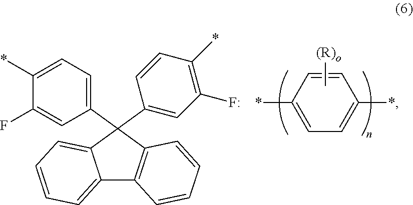
wherein R is the same or different each time it appears and each independently F, CF₃ or OCF₃; o is the same or different each time it appears and each independently an integer of 0-4; n is an integer of 1-3, provided that at least one o is an integer from 1 to 4.

16. The polyimide of claim 14, wherein the D is each independently selected from

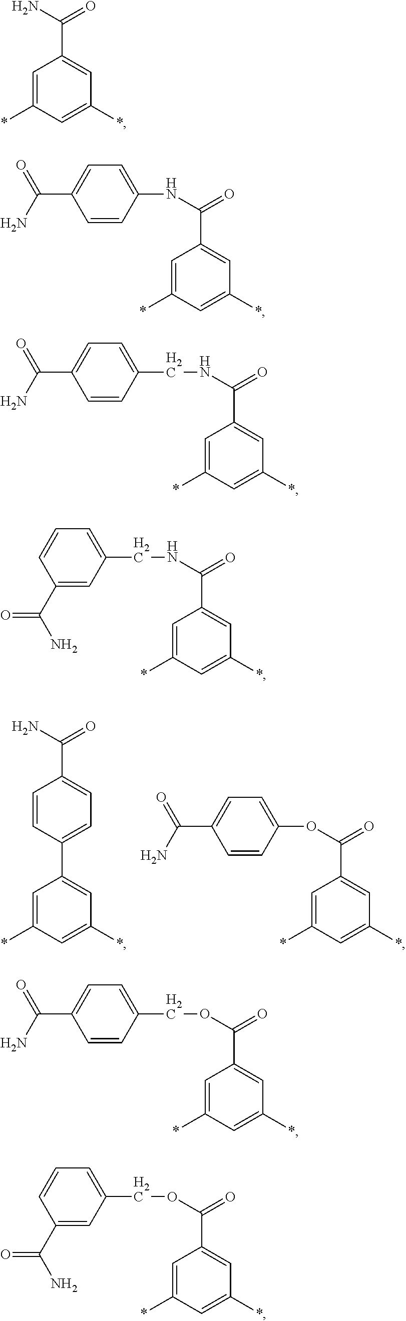

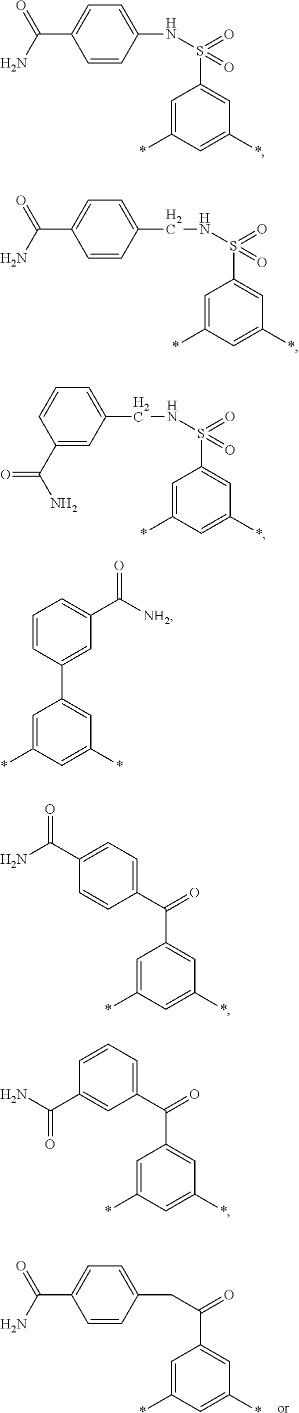

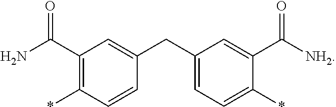 [SMILES: *c1ccc(Cc2ccc(*)c(C(N)=O)c2)cc1C(N)=O]

17. The polyimide of claim 15, wherein the E is each independently selected from 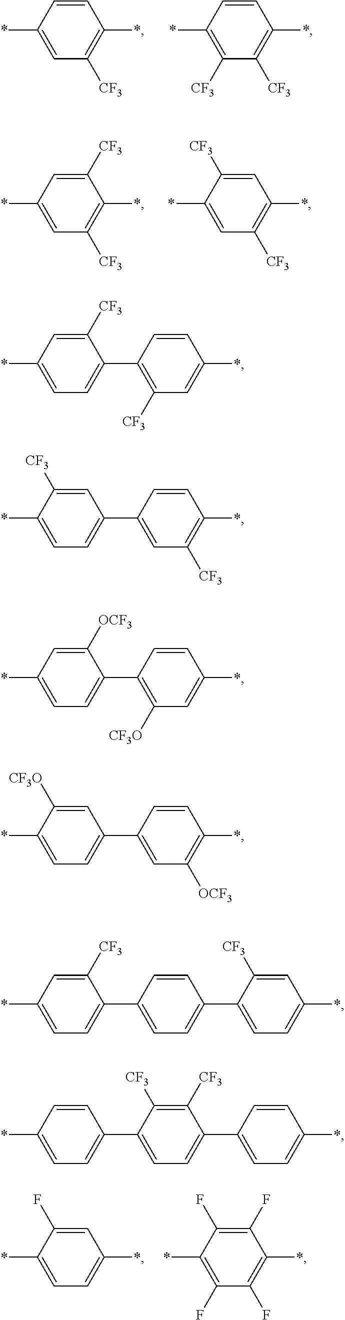 [chemical structure]
